(19) United States
(12) Patent Application Publication
(10) Pub. No.: US 2013/0034280 A1
(43) Pub. Date: Feb. 7, 2013

(54) MEDICAL TECHNOLOGY SYSTEM AND OPERATING A METHOD THEREFOR WITH REDUCED TIME REQUIRED FOR ACQUISITION OF PROJECTION IMAGES

(71) Applicants: Dominik BERNHARDT, Hausen (DE); Fernando VEGA-HIGUERA, Erlangen (DE)

(72) Inventors: Dominik BERNHARDT, Hausen (DE); Fernando VEGA-HIGUERA, Erlangen (DE)

(21) Appl. No.: 13/565,995

(22) Filed: Aug. 3, 2012

(30) Foreign Application Priority Data
Aug. 3, 2011 (DE) 10 2011 080 333.5

(51) Int. Cl. G06K 9/36

(52) U.S. Cl. 382/128

(57) ABSTRACT

In a method to control a medical technology system with a projection image acquisition apparatus, planning images that were previously selected in a planning step and generated from previously generated volume data are used, and orientation data are associated with the planning images. For this purpose, an output of the planning images at a display device initially takes place. A selection signal to select a planning image is then registered, and acquisition parameters are determined using the orientation data of the selected planning image. The medical technology system is controlled based on the acquisition parameters to acquire a current projection image and the current projection image is displayed.

### BACKGROUND OF THE INVENTION

1. Field of the Invention

The present invention concerns a method to control a medical technology system in which current projection images are acquired by means of a projection image acquisition apparatus at time intervals during the operation of the medical technology system, and are displayed on a display device. Moreover, the invention concerns a medical technology system with a projection image acquisition apparatus to generate projection images of a patient with which the method according to the invention can be implemented. The invention also concerns an image data processing station as well as A non-transitory, computer-readable data storage medium.

2. Description of the Prior Art

A procedure known as invasive angiography is often implemented to examine pathological cardiac vessels. For this purpose, a catheter is introduced (guided or manually, for example) into a blood vessel of the patient via an access and this catheter is navigated through the blood vessels up to the blood vessel segment that is to be examined. A current projection image is respectively generated at each of a number of time intervals with the projection image acquisition apparatus, for example an x-ray radioscopy apparatus or angiography apparatus that is specifically designed for angiographic examinations. Such an angiography apparatus most often has a C-arm that can be panned around the patient, on which C-arm at least one x-ray radiator is located opposite at least one x-ray detector. In order to make the blood vessel particularly well visible in the projection images, contrast agent is often used that can be injected via the catheter. A typical method that is used is known as digital subtraction angiography in which a blank exposure is initially produced before the contrast agent administration, and this blank exposure is subsequently subtracted from a second exposure after the contrast agent administration. Interfering image elements (such as bone structures) that are present in both exposures are thereby masked out. In order to reduce the amount of administered contrast agent, the medical personnel generally navigate through the blood vessels without a visualization of these vessels. Contrast agent is injected only at a few points that are difficult to navigate. Therefore, the only catheter itself is sufficiently visible within the current projection images since, due to its absorption of x-ray radiation, it is always set apart from the surrounding anatomy given a use of a typical x-ray apparatus, for example. Such a navigation of the razor-thin catheter in the uncontrasted blood vessel requires a great deal of experience and practice. Unexpected curves of the blood vessels, obstructions such as stenoses or local occlusions often hinder the navigation of the catheter. The threading of the catheter into the individual coronary vessels (in the heart, for example) is particularly difficult. The cardiologist controls the catheter tip along the aortic arch toward the ostia (the outlet into the two main branches of the right and left coronary artery). This is a time-consuming and relatively complicated task that can be implemented quickly and reliably only by experienced and well-trained personnel. Given hindered accesses into the ostia or into the blood vessel itself, damage to the inner wall of the blood vessels can occur due to the invasive method.

In order to better take the risks of this procedure into account so as to preclude or evaluate coronary stenoses, a non-invasive angiography—known as a coronary angiography (CCTA—Coronary Computer Tomography Angiography)—is frequently implemented before such an invasive angiography by means of a computed tomography (CT) or another apparatus with which volume data can be generated, for example with a magnetic resonance tomography apparatus (MRT), positron emission tomography apparatus (PET), single photon emission tomography apparatus (SPECT) and/or a similar apparatus. Alternatively, apparatuses can be used that do not directly deliver volume data but rather generate such volume data from image data sets in an image processing (for example a reconstruction). Volume data in the sense of the invention are three-dimensional data appropriately generated or reconstructed by means of an imaging medical technology system, which three-dimensional data include spatially (and possibly also temporally) resolved information about the condition of a defined volume region of the examination subject. For example, they can be a set of slice images through the appertaining volume region. Volume images in the sense of the invention are all images generated from the volume data, such as projections, slice images or 3D views, for example what are known as VRT images (VRT=volume rendering technique) or MPR/MIP images (MPR=multiplanar, MIP=maximum intensity projection).

With the use of the volume data, the blood vessels can be made significantly more visible in terms of their spatial structure. Therefore, during an invasive angiography one or more planning images generated from the volume data are normally positioned (in the form of printouts or on other monitors) next to the display of the respective current position images.

In order to track the curve of a blood vessel during an invasive angiography, it is necessary to vary (among other things) the projection angle of the projection image acquisition apparatus with which a current projection image is generated. However, one problem in the navigation is the spatial association of the attitude of the blood vessel to be examined (that is shown in the respective current projection images) with the blood vessel shown in the volume images. The person who navigates the catheter must continuously switch back and forth between the spatial presentation in the volume images (which is essentially a type of static map of the area in which the catheter tip is navigated) and the orientation of the current projection image which replaces the current view of the person. Naturally, this increases the risk of error. Moreover, in many cases the person must generate multiple projection images from various projection directions in order to find the correct projection angle which supplies him or her with projection images that are usable for the next navigation segment. This leads to the patient being exposed to an increased radiation dose.

A method to control a medical technology system is known from DE 10 2008 045 276 A1, in which projection images of a hollow organ are acquired at time intervals by means of a projection image acquisition apparatus of the medical technology system and are displayed on a display device, and volume images of the hollow organ that are generated from previously generated volume data of the hollow organ are respectively displayed in parallel on a display device, wherein the display of a current projection image and the display of a volume image of the hollow organ are automatically shown by the display device, correlated with one another in terms of position.

If the operator thus operates the C-arm of the medical technology system with a joystick in order to move it into a different projection angle, the volume image is thus already modified in parallel with this so that a view in the volume image is shown that would correspond to the projection image that would be generated in the appertaining position of the C-arm. If the operator then triggers the x-ray apparatus of the C-arm via the typical foot switch (and thus confirms the correct setting by means of a confirmation signal), a corresponding projection image is generated, whereby it is ensured that a volume image correlated to this projection image is immediately displayed at the same time. Since the operator already sees in advance which projection image he or she can expect in the respective projection direction, this leads to the situation that no unnecessary projection images from incorrect projection angles must be acquired. The amount of contrast agent can additionally be reduced.

However, even in this procedure it is still necessary for the operator to manually navigate the projection image acquisition apparatus to the respective point at which the required projection image can be made. The operator must then direct his or her attention not only to the catheter but also to the control of the projection image acquisition apparatus. This procedure additionally takes time, which leads to a longer total examination time. In order to unburden both the patient and the operator, a reduction of the total examination time would be desirable.

### SUMMARY OF THE INVENTION

An object of the present invention is to provide an improved method to control a medical technology system, as well as a medical technology system of the aforementioned type, so that the time to control the projection image acquisition apparatus can be reduced.

In the method according to the invention, planning images are used to directly control the projection image acquisition apparatus to produce projection images of an examination subject during a current acquisition session, which planning images were created and selected in a planning step or in a planning phase before the beginning of this current diagnostic data acquisition session on the basis of previously generated volume data of the appertaining examination subject. These volume data were created in an arbitrary earlier acquisition session at the same apparatus or at a different suitable apparatus (most often a CT or MRT apparatus). An acquisition session in this sense is a contiguous acquisition process with a medical imaging technology apparatus in which multiple exposures of the examination subject are made and/or a complete volume region of the examination subject is acquired. For example, the earlier acquisition session can be a non-invasive angiography described above for a subsequent diagnosis and/or planning of an additional procedure, and the current acquisition session can be an angiography which serves to assist the navigation in a catheter examination. In this case, during the planning phase a plurality of planning images that show the heart and one or more blood vessels and/or another hollow organ from varying perspectives and/or varying segments of these relevant structures is generated for the later acquisition session on the basis of the volume data. As was already explained above, such plannings have for the most part been implemented previously anyway before invasive angiographies so that the executing personnel can prepare the procedure and receive an overview of the possible difficulties that are to be expected.

Since only the volume data from an earlier acquisition session are required in this planning step, this step can be implemented independently of the actual projection image acquisition apparatus of a medical system and without the presence of the patient, for example at an arbitrary suitable workstation which is equipped in the manner according to the invention as described later.

According to the invention, orientation data that include information about from which viewing direction (for example with which “virtual projection angle”) the views of the volume data that are reproduced in the planning images were created are associated with the planning images. The orientation data can also include information about which image section reproduces the planning image generated from the volume data. For example, a sort of deck of cards for the navigation of the catheter is thus provided in the implementation of a planning of an invasive angiography after conclusion of the planning step.

For the control according to the invention of the medical technology system or, respectively, of the projection image acquisition apparatus, during the current acquisition session the planning images are then output for selection on a display device and a selection signal for selection of a planning image is registered. For example, with the use of a graphical user interface—in which graphical user interface the planning images are provided on a screen and can be marked or, respectively, activated with the aid of a pointer device (a mouse, for example) for selection—an operator can select one of the planning images selected in the planning step and that is currently displayed. In particular, the screen can also be a touchscreen so that an operator must only point to the desired image on the screen to select a planning image.

In addition, acquisition parameters are determined using the orientation data of the selected planning image. For example, the orientation data of the selected planning image can be used in order to determine acquisition parameters for the acquisition of the selection signal. Alternatively, matching acquisition parameters can also already be determined in advance for all planning images on the basis of the associated orientation data and can likewise be associated with the planning images. The control of the medical technology system to acquire a current projection image then takes place on the basis of the acquisition parameter belonging to the selected planning image. This current projection image is then displayed in a further step of the method. The same display device (which has a correspondingly divided display region, for example) can thereby be used to display the planning images and to display the current projection image. However, separate display devices can also be used.

Through the use according to the invention of the orientation data of the selected planning image to determine the acquisition parameters, the current projection image renders a view that essentially corresponds to the view of the selected planning image. It is consequently no longer necessary that the operator manually drives the projection image acquisition apparatus to the correct position (by means of a joystick, for example) in order to generate the desired projection image corresponding to the planning image. The method according to the invention consequently significantly simplifies the adjustment of the projection image acquisition apparatus and shortens the time period until the next desired projection image can be generated. This is particularly advantageous when—as is the case in invasive angiographies—a catheter tip must simultaneously be navigated by the operator. The operator can then direct the entirety of his concentration to the catheter navigation. In addition, through the method the total radiation dose can be reduced since intermediate steps to generate projection images for navigation of the catheter can be omitted since current projection images corresponding to the planning images are provided automatically via the method.

A medical technology system according to the invention has a projection image acquisition apparatus to generate projection images; a first display device to display the projection images; and an input interface to import planning images that were generated from previously generated volume data in a planning step, wherein orientation data are associated with the planning images. Such a medical technology system also has a second display device (which, as explained above, can be identical to the first display device or, respectively, can be combined with this) to display the planning images for the selection of a planning image, and a user interface to register a selection signal to select a planning image. Moreover, a converter unit to determine acquisition parameters to control the medical technology system on the basis of the orientation data of the selected planning image and a control unit to control the projection image acquisition apparatus on the basis of the acquisition parameters are required.

In addition to the component described above, the projection image acquisition apparatus can naturally also still have all additional components that are typical to such apparatuses, for example an x-ray source, a detector system, an image acquisition interface to read out the projection images from the detector system etc. Since such projection image acquisition apparatuses are fundamentally known to the man skilled in the art, a more detailed description of these typical components and their interactions is omitted here.

In addition, an image data processing station according to the invention is required to implement the method according to the invention, which image data processing station has a display control unit (in addition to an input interface to accept volume data generated with an imaging medical technology apparatus, a user interface with an input device to register control commands, and an image display unit) which is designed in order to display at the display unit a view generated from the volume data, based on control commands registered by the input device. As explained above, this can in principle be a typical workstation with which planning images for a later acquisition session have also been generated previously. According to the invention, however, this image data processing station must now additionally have a suitable memory interface that is designed in order to store a view generated from the volume data (linked with the orientation data belonging to the appertaining view) as a planning image based on control commands registered by the input device. This means that the image data processing station according to the invention must be designed so that the operator can occupy different virtual viewing angles in the planning, and the image data processing station links the associated orientation data with the planning image in some manner, at the latest upon a storage of a view as a planning image. As explained in detail below, these can be any orientation data. It is only decisive that it is unambiguously established from which direction relative to the examination subject the respective view was produced. The linking of the orientation data with the planning image can also occur in different ways. The storage of the orientation data advantageously takes place directly in the image files. Since the planning images (as well as most other medical technology images) are normally stored as DICOM files, the orientation data can particularly preferably be stored in a header of the DICOM file.

A majority of the components of the medical technology system and of the image data processing station to realize the invention, in particular the converter unit and control unit, can be realized wholly or partially in the form of software modules on a processor. The cited interfaces can be realized both as pure hardware components and as software modules, for example if the data of other software components already realized at the same apparatus can be accepted or, respectively, must be relayed in software. Naturally, the interfaces can also comprise hardware and software components, for example standard hardware interfaces that are specially configured via software. Therefore, the invention also encompass a non-transitory, computer-readable data storage medium which can be loaded directly into the memory of an image data processing station or a programmable control unit of a medical technology system and has program code segments in order to implement all steps of the method according to the invention when the program is executed in the image data processing station or, respectively, the control unit. Such a realization in software is inasmuch advantageous since image data processing stations and medical technology systems that are already present can also hereby be upgraded more easily in order to operate according to the method according to the invention.

During a current acquisition session, with the method according to the invention one planning image can be selected after the other (for example corresponding to an order established in the planning phase), and the medical technology system can thereupon respectively be controlled so that a current projection image corresponding to the selected planning image is generated and displayed. For this purpose, the planning images can be output for selection in various presentation modes. For example, the planning images can be automatically displayed in succession for a respective defined time duration, such that the rendering of the planning images results in a manner of film. However, for selection the planning images are particularly preferably output at least in groups in the form of an image gallery. An image gallery means a group of planning images arranged next to one another and/or under one another on a monitor, with or without overlapping, advantageously in rows and/or columns. The arrangement in the form of an image gallery allows the operator to quickly achieve an overview of the provided planning images.

For this purpose, the medical technology system advantageously has a display controller that is designed so that the planning images are output for selection in the form of an image gallery.

Since the patient normally does not have exactly the same position in the current acquisition session as in the earlier acquisition session, it is assumed that the position of internal structures of the patient (and thus also of the examination subject) has also varied. In particular, with the position the shape can also have varied within certain limits. In order to compensate for such variations, an image data alignment to form a transformation rule for a determination of the acquisition parameters from the orientation data is advantageously implemented before a control of the medical technology system takes place on the basis of a planning image (i.e. by means of the acquisition parameters that are based on the orientation data associated with the planning image). Furthermore, with the aid of this transformation rule the acquisition parameters for all selected planning images can then be correctly determined from the orientation data of the planning images in order to ensure that the displayed current projection image essentially corresponds to the selected planning image. This transformation rule thus forms a bridge between the two temporally separated acquisition sessions (which are normally implemented with different methods or different imaging apparatuses) to create the volume data for the planning images and to create the projection images.

This image data alignment advantageously takes place via a relative alignment to one another of at least one reference image (acquired by means of the projection image acquisition apparatus) hand and a planning image and/or the volume data. For example, this means that the reference image is aligned corresponding to the planning image or, respectively, the volume data. However, an alignment of the volume data or, respectively, planning images to the situation at the projection image acquisition apparatus preferably takes place in reverse via alignment relative to the reference image that is created with this.

In principle, the alignment can very simply take place in that only the virtual viewpoint (in particular view angles) of the planning images is correlated with the projection angles for the corresponding projection images. In order to create the transformation rule, the reference image is for example linked with position information which represents the position of the employed projection image acquisition apparatus at the acquisition of the projection image. Insofar as the imaging apparatus for the earlier acquisition session and the projection image acquisition apparatus for the current acquisition session operate with different coordinate systems, within the framework of this alignment it is ensured that the transformation rule comprises a conversion of the orientation data from the first coordinate system into a second coordinate system. For example, magnetic resonance tomography apparatuses and computer tomography apparatuses with which the volume data are normally acquired for planning operate in a Cartesian coordinate system, in contrast to which projection image acquisition apparatuses that are typically used within the scope of invasive angiographies operate in a polar coordinate system. Cartesian coordinates are accordingly particularly preferably converted into polar coordinates within the scope of the transformation rule.

In addition to such a mere coordinate transformation, however, the alignment can also include a continuative adaptation (advantageously a complete registration) of planning images or, respectively, the volume data and the reference images to one another. Not only affine transformations but also non-affine transformations of the image data can thereby be implemented in order to compensate for shifts, rotations, distortions etc. of specific structures (in particular organs) within the image data.

The medical technology system advantageously has a corresponding image data alignment unit to create a transformation rule. The image data alignment unit can thereby be designed so that the alignment (and accordingly the generation of the transformation rule) takes place wholly automatically. The image data can likewise also be manipulated by an operator until the desired alignment or adaptation has taken place, wherein the changes are protocolled as well in order to create the transformation rule. Furthermore, semi-automatic alignment or registration methods are also conceivable, wherein the adaptation takes place on the basis of markings set by the operator in a graphical user interface, for example.

At least one three-dimensional registration image (3D reference image) and at least one three-dimensional planning image (3D planning image) or the volume data can advantageously be used in the image data alignment. For example, such a 3D reference image can be created in that respective projection images are acquired from multiple angle positions along a revolution around the examination subject by means of the projection image acquisition apparatus, and then based on this a reconstruction of a volume region or, respectively, of the 3D planning images takes place.

Alternatively, the image data alignment can take place based on at least one 2D reference image and at least one 3D planning image or the volume data. The 2D reference image can be a simple projection image.

Multiple different reference images and/or planning images are thereby advantageously used for image data alignment. An alignment or registration that is sufficient to calculate the transformation rule can normally also take place in this manner even without a complete reconstruction of volume data from the reference images.

The acquisition of the reference images advantageously takes place at the beginning of the current diagnostic data acquisition session within the scope of an adjustment phase. The image data alignment can subsequently take place immediately in the adjustment phase in order to determine the transformation rule.

This transformation rule can then be respectively applied to the principle to the orientation data of a selected planning image during the current acquisition session in order to determine the current acquisition parameters and to suitably control the medical technology system or, respectively, the projection image acquisition apparatus. In a preferred embodiment variant, all planning images or at least one group of planning images are retrieved (if applicable still within the scope of the adjustment phase), and the associated orientation data are then converted into the matching acquisition parameters with the aid of the transmission rule and are stored again, linked with the planning images. This allows the desired position to be more quickly reached after selection of a planning image, and for example allows the phase of the catheter navigation to be shortened given an invasive angiography.

In order to shorten the total time for the current acquisition session, including the adjustment phase, it is also possible to already implement the conversion of the orientation data into the acquisition parameters beforehand (insofar as no reference image is required). For example, a conversion between two coordinate systems can already take place in advance, in particular in the generation of the planning images. It is thus in fact preferably possible to operate in Cartesian coordinates in the generation of the planning images from the volume data, but to then already implement a first portion of the transformation and to convert the Cartesian coordinates into polar coordinates and to store them in this form as orientation data, linked with the planning image.

The method is advantageously designed so that additional control signals to control the medical technology system are initially acquired by means of a user interface, after a control based on a planning image but before a generation of a projection image. For example, these additional control signals can be a confirmation signal with which the operator verifies the correct position of the projection image acquisition apparatus and triggers the acquisition. As a part of the user interface, the typical foot switch can be used to trigger the x-ray radiation. However, the additional control signals can also be signals that the operator inputs by means of a movement control unit (a joystick, for example) in order to implement a manner of readjustment of the projection image acquisition apparatus before the projection image is acquired. For example, the conformation or, respectively, the triggering of the x-ray radiation by the operator that are described above can then take place. With the aid of these additional control signals, the operator can similarly also generate additional current projection images with views deviating from the planning images. In particular, the method according to the invention can hereby also be combined with the method described in DE 10 2008 045 276 A1.

### BRIEF DESCRIPTION OF THE DRAWINGS

FIG. 1 is a schematic representation of an exemplary embodiment of a medical technology system according to the invention.

FIG. 2 is a representation of a display device of the medical technology system according to FIG. 1 that reflects an image gallery.

FIG. 3 is a block diagram of an exemplary embodiment of the medical technology system according to FIG. 1 and FIG. 2.

FIG. 4 is a block diagram of an exemplary embodiment of an image data processing station according to the invention.

FIG. 5 is a flowchart of an exemplary embodiment of the method according to the invention.

### DESCRIPTION OF THE PREFERRED EMBODIMENTS

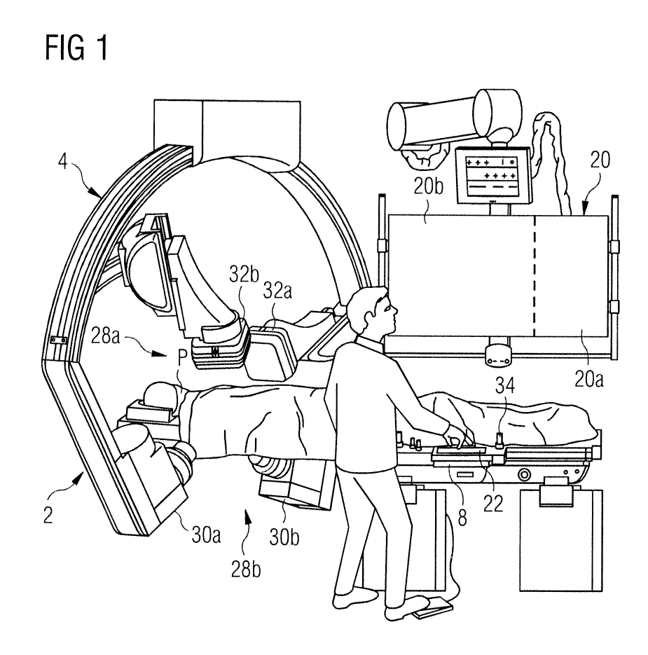

As an exemplary embodiment of a medical technology system 2, FIG. 1 shows an angiography system 2 that has a patient bed 22 on which a patient P is arranged whose pathological cardiac vessels should be examined within the scope of an invasive angiography.

A projection image acquisition apparatus 4 is positioned around the upper body of the patient P, which projection image acquisition apparatus 4 is fashioned as what is known as a C-arm 4 on which are arranged here two x-ray devices 28a, 28b with a respective x-ray radiator 30a, 30b and an opposite x-ray detector 32a, 32b. Two images offset by 90° relative to one another can be generated with the aid of the x-ray radiators 30a, 30b and the x-ray detector 32a, 32b. There are also such C-arms 4 with only one x-ray radiator and an opposite detector that, for example, can be used in the same manner within the scope of the invention.

A responsible person (the operator) can control the projection acquisition apparatus 4 via a user interface 8 with a joystick 34 at the patient bed 22 in order to move the C-arm 4 around the patient P, for example, and in order to thus vary the projection angle of the current projection acquisition. A catheter that would be introduced into a blood vessel of the patient P can be navigated via additional operating elements.

The image data acquired with the C-arm 4 can be displayed on a display device 20 (frequently also designated as a monitor lamp) that can be subdivided by a controller to show multiple images so that the display region of the display device 20 is subdivided into a first display device 20a and a second display device 20b. There can also be multiple monitors that are mechanically coupled, for example. Multiple monitor lamps can also likewise be used next to one another that thus form the entire display device 20.

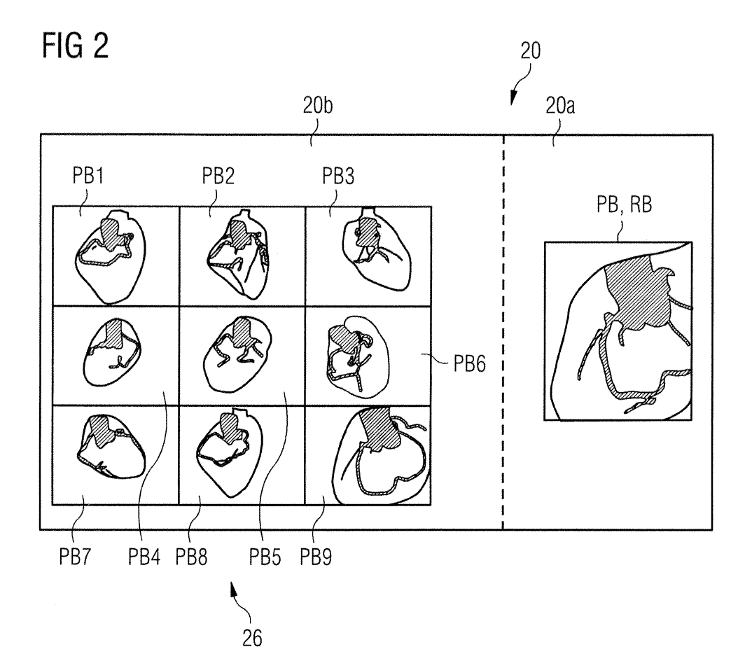

FIG. 2 shows the entire display device 20 with the two segments that form the first display device 20a and second display device 20b.

The first display device 20a shows a set of planning images PB1, . . . , PB9 that here are arranged, with three rows and three columns, next to and below one another, in the form of matrix-like image gallery 26.

In contrast to this, the second display device 20b shows a current projection image PB that is generated with the C-arm 4 at the point in time of the examination. Such a projection image PB generated at the beginning of a current acquisition session can also be used as a reference image RB within the scope of the method according to the invention, as is described in the following.

For example, given an invasive angiography the operator can select one of the planning images PB1, . . . , PB9 of the image gallery 26 by means of the user interface 8—for example with the aid of the joystick 34 in an image selection mode or with the aid of a mouse (not shown in FIG. 1)—and thus (as is explained later) have the effect that the second display device 20b delivers as a current projection image PB an image corresponding to the selected planning image PB1, . . . , PB9.

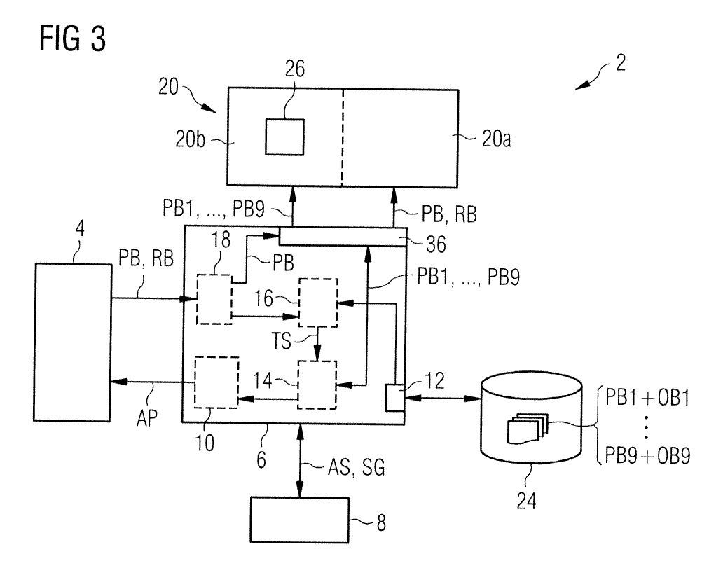

The components of the angiography system 2 shown in FIGS. 1 and 2 are presented in FIG. 3 in the form of a block diagram in order to explain their interaction.

The angiography system 2 initially has a central control device 6. The control device 6 is connected with the user interface 8 so that different signals (such as selection signals AS or control signals SG) can be transmitted from the user interface 8 to the control device 6.

Among other things, the control device 6 itself has as essential components an acquisition apparatus control unit 10, a memory interface 12 (serving here within the scope of the invention as an input interface 12), a converter unit 14, an image data alignment unit 16 and an image acquisition interface 18.

The memory interface 12 is connected for data exchange with a mass storage 24 in which are stored previously generated planning images PB1, . . . , PB9 with their associated orientation data OD1, . . . , OD9.

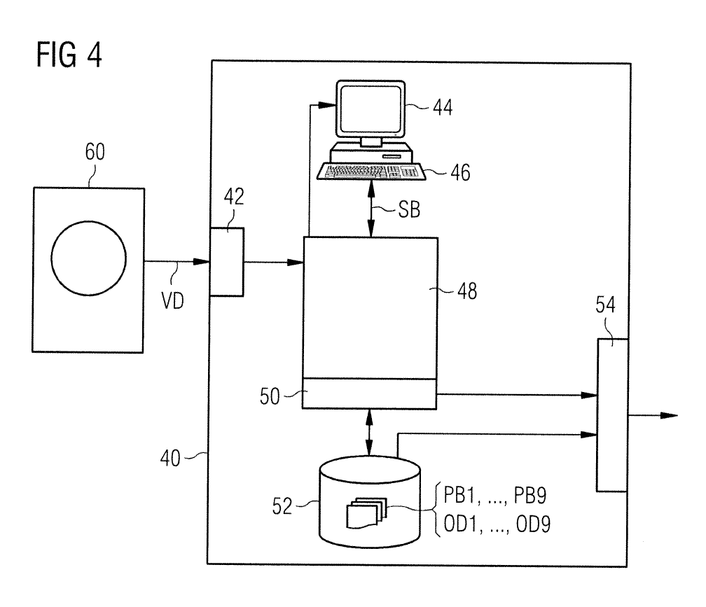

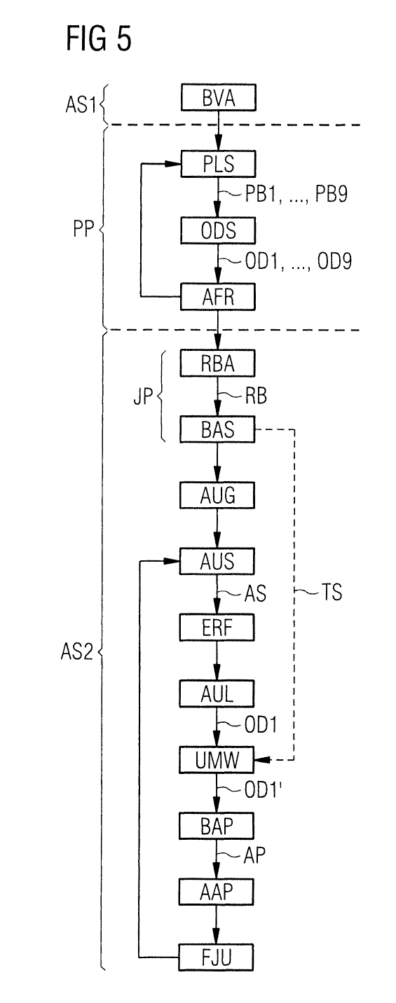

The mass storage 24 can be a component of the angiography system 2, or for data exchange can be connected with the angiography system 2 via a network, in particular an RIS (radiological information system). Such a network connects a plurality of additional modalities (imaging apparatuses), mass storages, servers, assessment stations, printers etc. among one another. Additional powerful computers are therefore typically located separately from the angiography system 2 on the network, at which computers other volume data processing units (i.e. corresponding image processing software) are further implemented in order to create and process the planning images PB1, . . . , PB9 (with their orientation data OD1, . . . , OD9) located in the mass storage 24, as this is explained again in the following using FIGS. 4 and 5.

The control device 6 is also connected with the display device 20 via a display controller 36, wherein the display controller 36 is designed so that it enables (among other things) the reproduction of the planning images PB1, . . . , PB9 loaded from the mass storage 24 on the second display device 20b in the form of the image gallery 26.

Moreover, the control device 6 is connected via the acquisition apparatus control unit 10 with the projection image acquisition apparatus 4 in order to transfer acquisition parameters AP (for example the coordinates of the position to be taken up next for the generation of a current projection image) to the projection image acquisition apparatus 4. As is explained in the following, the acquisition parameters AP are determined by the converter device 14 (with the aid of the image data alignment unit 16) from orientation data OD1, . . . , OD9 associated with the selected planning images PB1, . . . , PB9.

One or both x-ray detectors 32a, 32b on the C-arm 4 are read out in alternation via the image data acquisition interface 18, and a current projection image PB is reconstructed from the data, which projection image PB is transferred via the display controller 36 to the display device 20, which renders this on the second display device 20b.

As mentioned above, by means of the user interface 8 the operator can make a selection from the planning images PB1, . . . , PB9 that are displayed in the image gallery 26 on the second display device 20b. The converter unit 14 thereupon determines acquisition parameters AP on the basis of the orientation data OD1, . . . , OD9 belonging to the selected planning image PB1, . . . , PB9, which acquisition parameters AP are then transferred to the C-arm 4 and thus have the effect that the C-arm 4 acquires a current projection image PB corresponding to the selected planning image PB1, . . . , PB9, which current projection image PB is shown on the second display device 20b of the display device 20. For this the converter unit 14 uses a transformation rule TS that—as is explained in detail in the following—is created with the aid of the image data alignment unit 16 using a few reference images RB acquired with the C-arm 4.

FIG. 4 shows a roughly schematic block diagram of an image data processing station 40 designed according to the following, for example an assessment station (realized at a suitable workstation) that is designed in the manner according to the invention. This image data processing station 40 is connected via an input interface 42 with a tomography system 60 (indicated only symbolically here) from which it accepts volume data VD of an examination subject. This input interface 42 can be an apparatus interface via which the tomography system 60 is connected directly with the image data processing station 40, or a network interface via which the image data processing station 40 has access via a network (RIS) to the volume data VD generated by a tomography system 60. Moreover, the image data processing station 40 has a user interface with an input device 46 (a mouse and/or keyboard, for example) and an image display unit 44, as well as a display control unit 48. Based on control commands SB received by the input device 46, the image display unit 44 generates from the volume data 44 a defined view that is then output to the display unit 44. With the use of the input device 46 and the image display unit 44, an operator can thus create multiple planning images PB1, . . . , PB9 for a subsequent acquisition session from the volume data VD, which planning images PB1, . . . , PB9 respectively show defined views of the examination subject.

These planning images PB1, . . . , PB9, together with orientation data OD1, OD9, are then stored in a memory 52 by a specially designed memory interface 50, wherein the orientation data OD1, . . . , OD9 respectively include the information about the viewing direction towards the examination subject. The planning images PB1, . . . , PB9 can be stored in a DICOM format, and the orientation data are thereby preferably stored in the header of the DICOM at the entry positions “Primary Angle” (018,1510) and “Secondary Angle” (018,1511). These entry positions have previously not been defined in the DICOM standard for exposures from computer tomographs or magnetic resonance tomography apparatuses, and therefore are free. Alternatively or additionally, the planning images PB1, . . . , PB9 with the associated orientation data OD1, . . . , OD9 can also be output via an output interface 54 (wherein it can again be a network interface, possibly even the same network interface as the input interface 42) and, for example, be stored in the mass storage 24 according to FIG. 3 so that they can be used further from there. In particular, a transfer of planning images PB1, . . . , PB9 (with the associated orientation data OD1, . . . , OD9) generated earlier from the memory 52 is also possible via this output interface 54.

A typical workflow of the method according to the invention to control the angiography apparatus 2 with the C-arm 4 is explained in the following using FIG. 5, using an invasive angiography as an example examination.

During a first acquisition session AS1 with a first imaging apparatus (a magnetic resonance tomography apparatus or computer tomography apparatus, for example), volume data VD are generated in a first step BVA.

Within the scope of a planning phase PP (which is implemented with the aid of the image data processing station 40 explained using FIG. 4, for example), the volume data VD are then used in order to obtain a set of planning images PB1, . . . , PB9.

For this, in a planning step PLS an operator initially selects a first planning image PB1 that he or she considers to be reasonable and helpful for the implementation of the later invasive angiography. This occurs in that the operator (via the user interface at the image data processing station 40) can display in the volume data various virtual views of the subject of interest—in an invasive angiography the blood vessels through which he must later navigate with a catheter.

In a further step ODS, this planning image PB1 is stored together with the associated orientation data OD1 which represent the position information about the viewing direction. As was explained above, this advantageously takes place in that the planning image is stored in the DICOM format and the associated orientation data OD1 are stored as well in the DICOM header of the planning image PB1.

In a subsequent step AFR a query is then made as to whether the operator wants to create additional planning images. If this is the case, a jump back to the step PLS takes place and an additional planning image PB2 is created and stored together with the associated orientation data OD2 in the step ODS.

This loop is run through until the desired number of planning images PB1, . . . , PB9 with the associated orientation data OD1, . . . , OD9 are created and stored in a memory. The planning phase PP is then concluded.

For a subsequent invasive angiography, in this planning phase PP the planning images PB1, . . . , PB9 are reasonably selected so that they optimally well represent the blood vessel course along which a catheter must be navigated at various positions and from different viewpoints. In particular, the critical points (such as curves and stenoses) should be well represented by these planning images PB1, . . . , PB9. The planning images PB1, . . . , PB9 then yield a sort of “deck of cards” that, for the operator, facilitates the navigation of the catheter during the later implementation of the invasive angiography in the second acquisition session AS2.

The two acquisition sessions AS1, AS2 as well as the planning phase PP can moreover be implemented at a nearly arbitrary time interval relative to one another. For example, the first acquisition session AS1 can take place a few days before the second acquisition session AS2, and the planning phase PP can take place at an arbitrary point in time in-between.

At the beginning of the second acquisition session AS2, within the scope of an adjustment phase JP suitable reference images RB are then initially acquired with the angiography system 2 in a step RBA. For example, this adjustment phase JP can take place here before the insertion of a catheter. The reference images RB are used in a next step BAS in order to align the volume data VD and/or the planning images PB1, . . . , PB9. Given this alignment, a registration of the planning images PB1, . . . , PB9 and/or volume data with the reference images RB can take place in order to compensate for the different attitude of the patient P (and thus the different attitude and shape of the vessels) in the different imaging apparatuses used during the two acquisition sessions.

As a result the Step BAS delivers a transformation rule TS that, in the later course of the method according to the invention, allows acquisition parameters AP to be determined from selected orientation data OD1, . . . , OD9, with which acquisition parameters AP the C-arm 4 can be controlled so that a current projection image PB corresponding to the associated planning image PB1, . . . , PB9 can be created. The transformation rule TS can include a coordinate transformation from a first coordinate system (that the first imaging apparatus with which the volume data VD were generated uses) into a second coordinate system (that the angiography system 2 uses).

The output of the image gallery 26 with the planning images PB1, . . . , PB9 to the second display device 20b as shown in FIG. 2 then takes place in step AUG. For this the planning images PB1, . . . , PB9 with their orientation data OD1, . . . , OD9 are loaded (from the mass storage 24, for example) and loaded via the input interface 12 into the control device 6 and transferred to the display device 20b, which renders these (see FIG. 3). In a deviation from the representation in FIG. 5, the presentation of the image gallery 26 on the second display device 20b can take place right at the beginning of the invasive angiography.

The control device 6 of the angiography system 2 subsequently initially transitions into a wait mode. When an operator would like to select one of the planning images PB1, . . . , PB9 from the image gallery 26, in a step AUS a selection signal AS is generated by means of a user interface. This selection signal AS is transferred to the control device 6 in a step ERF.

The control device 6 thereupon leaves the wait mode, and a readout of the header of the DICOM file of the selected planning image PB1 takes place in a step AUL. In a step UMW the transformation rule TS obtained in a step BAS is subsequently used in order to convert the present orientation data OD1 into transformed orientation data OD1′ that include angle coordinates of the C-arm 4 that match the view of the selected planning image PB1. For example, these transformed orientation data OD1 can be present in the polar coordinate system of the C-arm 4. Moreover, however, as described above the different attitude of the examination subject is also taken into account in the conversion of the orientation data. This transformation or conversion UMW is implemented by the converter unit 14 (see FIG. 3).

Furthermore, the subsequent step BAP is also implemented by the converter unit 14 in that the matching acquisition parameters AP are determined on the basis of the transformed orientation data OD1′, with which acquisition parameters AP the C-arm 4 must be controlled so that it drives into the correct position. For example, here acquisition parameters AP in the form of step motor control signals with which step motors (not shown) can be controlled to move the C-arm 4 can be generated on the basis of the orientation data OD1′.

The acquisition parameters AP are transferred from the converter unit 14 to the control unit 10 of the control device 6 (see FIG. 3), which—in a step AAP—has the effect that the C-arm 4 drives into the correct position so that a current projection image PB can be generated which has essentially the same point of view as the selected planning image PB1, for example when the operator triggers an acquisition by means of a typical foot switch.

In a step FJU the operator can optionally still implement a fine adjustment with regard to the positioning of the C-arm 4 by means of the user interface 8 (by means of the joystick 34, for example).

When the current projection image PB is displayed on the second display device 20b, using this view the operator can navigate the catheter further. The control device 6 of the angiography system 2 again switches into the wait mode and waits for a new selection of a further planning image to take place in a step AUS.

As is apparent from the preceding example, the method according to the invention has a plurality of advantages. The operator has a fast access across all planning images, and the transfer of the orientation data to the control unit (in order to control the C-arm) is fast, transparent to the operator and simple to operate and modify during an intervention. Since a generic interface is also provided between image data processing stations with which a planning of subsequent acquisition sessions can take place and the imaging apparatuses to implement the acquisition session, it is in particular no longer necessary to create new applications for the apparatuses in order to provide new intervention methods. Such a generic interface thus also reduces the implementation costs for various applications or, respectively, allows a modular design of new multi-modality intervention workflows with very low implementation costs.

The methods and designs described in detail in the preceding are exemplary embodiments, and that the basic principle can also be varied by those skilled in the art within wide ranges without leaving the scope of the invention. In particular, the angiography system and the image data processing station that are explained in the preceding using Figures can have a plurality of additional components (not shown in the figures for the purpose of simplification) that such systems or such an image data processing station typically have.

In general, although modifications and changes may be suggested by those skilled in the art, it is the intention of the inventors to embody within the patent warranted hereon all changes and modifications as reasonably and properly come within the scope of their contribution to the art.

We claim as our invention:

1. A method for operating a medical technology system comprising a projection image acquisition apparatus, said method comprising:
prior to operating said projection image acquisition apparatus to acquire diagnostic projection images from an examination subject, providing a computerized processor with planning images of the examination subject generated from volume data previously acquired from the examination subject, and linking orientation data with the respective planning images;
also prior to acquiring said diagnostic projection images, displaying said planning images at a display device in communication with said computerized processor;
also prior to acquiring said diagnostic projection images, detecting, in said computerized processor, a selection signal that selects one of said planning images displayed at said display device;
also prior to acquiring said diagnostic projection images, determining, in said computerized processor, acquisition parameters for acquiring a diagnostic projection image corresponding to the selected planning image, using the orientation data linked with the selected planning image;
from said computerized processor, controlling operation of said projection image acquisition apparatus according to said acquisition parameters in order to acquire said diagnostic projection image; and
displaying said diagnostic projection image at said display device.

2. A method as claimed in claim 1 comprising presenting said planning images at said display in groups forming an image gallery.

3. A method as claimed in claim 1 comprising also before acquiring said diagnostic projection image, implementing an image data alignment in said computerized processor to calculate a transformation rule for determining said acquisition parameters from said orientation data linked to the selected planning image.

4. A method as claimed in claim 3 comprising implementing said image data alignment to produce a relative alignment of at least one reference image generated by such projection image acquisition apparatus and the selected planning image.

5. A method as claimed in claim 4 comprising generating said reference image as a 3D image and generating said planning images respectively as 3D images.

6. A method as claimed in claim 4 comprising generating said reference image as a 2D reference image and generating said planning images.

7. A method as claimed in claim 4 comprising generating multiple, different reference images and implementing said relative alignment using said multiple, different reference images.

8. A method as claimed in claim 3 comprising implementing said image data alignment as a relative alignment of at least one reference image generated by said projection image acquisition apparatus and said volume data.

9. A method as claimed in claim 8 comprising generating said reference image as a 3D reference image and generating said volume data as 3D volume data.

10. A method as claimed in claim 8 comprising generating said reference image as a 2D reference image and generating said volume data as 3D volume data.

11. A method as claimed in claim 8 comprising generating multiple, different reference images and implementing said relative alignment using said multiple, different reference images.

12. A method as claimed in claim 1 comprising, before acquiring said diagnostic projection image, implementing an image data alignment to calculate a transformation rule for determining said acquisition parameters from said orientation data, said transformation rule representing a conversion of said orientation data from a first coordinate system into a second coordinate system.

13. A method as claimed in claim 1 comprising linking said orientation data with the respective planning images by storing respective orientation data in respective headers of the respective planning images.

14. A method as claimed in claim 1 comprising, after acquiring said diagnostic projection image, generating additional control signals in said computerized processor by user interaction via a user interface of said computerized processor, before acquiring a next diagnostic projection image.

15. A medical technology system comprising:
a projection image acquisition apparatus;
a computerized processor;
a display device in communication with said computerized processor;
prior to operating said projection image acquisition apparatus to acquire diagnostic projection images from an examination subject, providing a computerized processor being configured to receive therein planning images of the examination subject generated from volume data previously acquired from the examination subject, and to link orientation data with the respective planning images;
also prior to acquiring said diagnostic projection images, said computer processor being configured to display said planning images at said display device;
also prior to acquiring said diagnostic projection images, detecting, in said computerized processor being configured to detect, a selection signal provided thereto that selects one of said planning images displayed at said display device;
also prior to acquiring said diagnostic projection images, determining, in said computerized processor being configured to determine acquisition parameters for acquiring a diagnostic projection image corresponding to the selected planning image, using the orientation data linked with the selected planning image;
said computerized processor being configured to control operation of said projection image acquisition apparatus according to said acquisition parameters in order to acquire said diagnostic projection image; and
said computerized processor being configured to display said diagnostic projection image at said display device.

16. A medical technology system as claimed in claim 15 wherein said display device is a processor display device communicating solely with said computerized processor, and wherein said medical technology system comprises a projection image acquisition apparatus display device communicating with said projection image acquisition apparatus, and wherein said diagnostic projection images are displayed at said projection image acquisition apparatus display device.

17. A medical technology system as claimed in claim 15 wherein said computerized processor is configured to cause said planning images to be displayed at said display device as an image gallery.

18. A medical technology system as claimed in claim 15 wherein said computerized processor is configured to implement an image data alignment of images and to calculate a transformation rule from said image data alignment.

19. An image data processing apparatus comprising:
a computer;
a display device in communication with said computer;
sad computer having an input configured to receive, prior to operating a projection image acquisition apparatus to acquire diagnostic projection images from an examination subject, planning images of the examination subject generated from volume data previously acquired from the examination subject;
said computer being configured to link orientation data with the respective planning images;
also prior to acquiring said diagnostic projection images, said computer being configured to display said planning images at said display device;
also prior to acquiring said diagnostic projection images, said computer being configured to detect a selection signal provided thereto that selects one of said planning images displayed at said display device;
also prior to acquiring said diagnostic projection images, said computer being configured to determine acquisition parameters for acquiring a diagnostic projection image corresponding to the selected planning image, using the orientation data linked with the selected planning image;
said computer being configured to control operation of said projection image acquisition apparatus according to said acquisition parameters in order to acquire said diagnostic projection image; and
said computer being configured to display said diagnostic projection image at said display device.

20. A non-transitory, computer-readable data storage medium encoded with programming instructions, said storage medium being loaded into a computerized processor of a medical technology system that also comprises a projection image acquisition apparatus, said programming instructions causing said computerized processor to:
prior to operating said projection image acquisition apparatus to acquire diagnostic projection images from an examination subject, receive planning images of the examination subject generated from volume data previously acquired from the examination subject, and making orientation data with the respective planning images;
also prior to acquiring said diagnostic projection images, displaying said planning images at a display device in communication with said computerized processor;
also prior to acquiring said diagnostic projection images, detect in said computerized processor, a selection signal that selects one of said planning images displayed at said display device;
also prior to acquiring said diagnostic projection images, determine acquisition parameters for acquiring a diagnostic projection image corresponding to the selected planning image, using the orientation data linked with the selected planning image;
control operation of said projection image acquisition apparatus according to said acquisition parameters in order to acquire said diagnostic projection image; and
display said diagnostic projection image at said display device.
